(19) United States
(12) Patent Application Publication
(10) Pub. No.: US 2009/0094073 A1
(43) Pub. Date: Apr. 9, 2009

(54) REAL TIME CLICK (RTC) SYSTEM AND METHODS

(75) Inventors: Dominic Cheung, South Pasadena, CA (US); Rana Anjum Ahmed, La Mirada, CA (US); Eugene Freeman Hu, Monrovia, CA (US); Robert K. Wong, Fullerton, CA (US); Muhammad Ali Siddiqui, Sherman Oaks, CA (US); Brian Wayne Sorkin, Pasadena, CA (US)

Correspondence Address: BRINKS HOFER GILSON & LIONE / YAHOO! OVERTURE, P.O. BOX 10395, CHICAGO, IL, 60610, US

(73) Assignee: Yahoo! Inc., Sunnyvale, CA (US)

(21) Appl. No.: 11/866,548

(22) Filed: Oct. 3, 2007

(51) Int. Cl. G06Q 10/00; G06F 17/18

(52) U.S. Cl. 705/7; 705/1; 705/30

(57) ABSTRACT

A real-time click system to process advertisement (ad) clicks includes a real-time listener operative to listen for, and store in a memory, a plurality of click event packets emitted by an ad server when corresponding ads are clicked by web users. A sequencer stores the click event packets in a database. A collector is coupled with the real-time listener and the sequencer and is operative to retrieve the plurality of click event packets, upon request, from the memory at a predetermined time interval. The collector also determines a partition number associated with each of the plurality of click event packets and sends to the sequencer the click event packets having a partition number corresponding to the sequencer.

### BACKGROUND

1. Technical Field

The disclosed embodiments relate to a distributed real-time system that collects, processes, and saves real-time click feeds generated from advertisements, making the data reliably available to other systems such as advertisement budgeting and forecasting systems.

2. Related Art

Various search marketing divisions of large search engine operators have repeatedly encountered revenue issues as a consequence of not being able to allocate budgeted accounts for Internet-based advertising of one or more advertisers over a period of time. For instance, in some circumstances, delays in the processing of charges against these accounts have impeded the search marketing division's ability recoup fees for their services. Search marketing describes the function of promulgating interactive sponsored search ads and display ads (among others) on behalf of an advertiser and tracking an Internet's user's interactions therewith according to advertisers' budgets, e.g., by recouping fees from the advertiser's account when a user interacts with an associated advertisement. As Internet users browse and search through the Internet selecting, i.e. “clicking,” various content they wish to view, their clicking activity, at least with respect to advertisement content, creates click events that may be charged against these budgets, such as when they click on an advertisement of a subscribing advertiser. The fee for this click-event, having been previously negotiated between the search marketing division and the advertiser, is charged against an account maintained by the advertiser with the search marketing division.

As a given advertiser may have many advertisements published on the Internet at any given time and available to many users, there may be multiple click-events generated at any given time over the course of periods for which the advertisements are available. It is necessary, therefore, that such click events are tracked and recorded promptly and consistently so that the budgets are adjusted accordingly, for example, to accurately control the availability of advertising such that the available budget is not consumed too quickly, which would limit the availability of the advertisement. Further, as will be discussed, the real-time nature of click-events complicates budgeting in a system that collects and accounts for those click-events in a general batch or non-real time process, resulting in the possibility that more click-events may be generated than the budget can cover. Liability for click-events for which the account has been exhausted may fall upon the search marketing division rather than the advertiser.

In particular, while the advertiser and search marketing division may endeavor to control the distribution and availability of a particular advertisement, during the time an advertisement is made available, it may be clicked on any number of times by any number of users. These click events must be captured and then processed against the account. Once the account is depleted, it may be desirable to remove the advertisements to avoid additional click events for which fees may not be able to be recovered. However, it is not uncommon to exhaust or “blow out” some of the budgets of advertisers due to delays in updating click event data required by budgeting agents to keep budgets updated. This may occur due to an unanticipated amount, distribution, and/or randomness of click activity, the processing of which is delayed. Any amount by which a budget is blown may be reimbursed to the advertiser or go uncharged, thus costing the search engine advertising revenue. A budgeting agent is a server or other computer-based system that receives the click event data and keeps the user account budgets up-to-date within budgeting goals while not exceeding account balances, among other administrative functions. If a budget is exhausted, the user account may be turned off so that no more advertising is displayed related to that account for the rest of the budgeting period (e.g., a day).

The budget updating delays are a result of delays in processing click events and making them accessible for query by budget agents that, for instance, require the raw click event data in order to update the advertisers' account balances and budgets. For example, a plurality of journallers may be dispersed throughout access locations to the Internet to listen for click events that are created when a user clicks on an advertisement link that is served on a web page. Each journaller may correspond to a certain set of advertiser accounts. When a journaller hears or detects a click event, that click event is stored in its persistent storage (e.g., a hard drive). More than one journaller may “hear” a given click and such duplicates must be resolved to avoid over-charging the advertiser. The click causes the web page to be re-directed to a serving system of an advertising broker (e.g., Yahoo!® or Google®), which acts as an intermediary to the advertiser and which uses the journallers. Upon redirect, a click event is emitted that the journaller recognizes and is able to track, and then the user's web page is further directed to the advertiser's website to which the user clicked. The click events that are stored in the persistent storage of the journallers are subsequently collected for later query access by the broker (or other budget agents).

The journallers are computer systems that are each separately connected to a corresponding dejournaller, which pulls (or retrieves) the saved click events at certain time intervals. A dejournaller pulls saved click event data only from specific journallers. Significant processing is required by the dejournallers to pull the click event data from the journallers because they are pulling the data from persistent storage. The processing is further increased by the need to then persist (or save) the click event data to another persistent storage, such as a database, available to budget agents for querying. (This saving step may further be exacerbated by the need to push the click data to a central server where the click event data is saved in a central database.)

Because the volume of saved click data in the journallers becomes so large, and the required processing by the dejouranllers so heavy, the typical time required between time intervals of pulling click events from the journallers is at least about 5 minutes and further processing and storing of the clicks may increase this delay. Many more click events could be (and typically are) on-going within that time, which results in outdated click event data being made available to budget agents at any given time and the corresponding potential to blow or overspend budgets. The journallers and dejournallers are part of current, traditional data pipelines that perform the above-mentioned click event data collection and processing.

The cause of budget update failure or delay varies from the regular delays in traditional data pipelines, e.g. of at least 5 minutes, to networking issues, to crashes of budgeting data bases, etc. Normal flow through these pipelines usually takes about 30-50 minutes due to high volumes of data on an average day. If network connectivity issues compound these normal delays, clicks can take up to two hours to propagate back to budgeting agents. If a traditional pipeline goes down, the click information in that pipeline is completely lost, potentially losing a large volume of click data that will never be available to budget agents to update their respective budgets.

### SUMMARY

By way of introduction, the embodiments described below are drawn to an . . .

In a first aspect, a system is disclosed to . . . TBD

In a second aspect, a method is disclosed for . . . TBD

In a third aspect, a method is disclosed for . . . TBD

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a system diagram of a distributed real-time click (RTC) system, depicting the various stages through which click data is passed and persisted.

FIG. 2 is an expanded portion of the system of FIG. 1, including a plurality of data pipelines formed from a plurality of listeners, backend components that include collectors and sequencers, and corresponding real-time click databases.

FIG. 3 is a system diagram depicting one pipeline extracted from the system of FIG. 1, including further details of the listener, the collector, and the sequencer.

FIG. 4 is a flow chart of a method executable on the system disclosed in FIGS. 1-3.

### DETAILED DESCRIPTION

As discussed previously, as Internet users browse and search through the Internet, their clicking activity creates click events that may be charged against the respective budgets of advertisers, such as when they click on an advertisement of a subscribing advertiser. The fee for this click-event, having been previously negotiated between a search marketing division and the advertiser, is charged against an account maintained by the advertiser with the search marketing division. As a given advertiser may have many advertisements concurrently published on the Internet and available to many users, there may be multiple click-events generated at any given time and from multiple potentially highly logically and/or geographically disperse sources over the course of a period for which the advertisements are available. It is necessary that such click events are tracked and recorded promptly and consistently so that the budgets are properly adjusted. Accurate and timely budgeting may, for example, allow for spreading use of the budget throughout the day to completely spend the budget while avoiding over-spending the budget. Exceeding the budget may cause a budget “blow out,” which usually requires that the search marketing division to forgo compensation for those click-events or reimburse the advertiser for the amount by which the account is over-spent for the budgeted period.

An advertiser's account and budget usually work in tandem. An advertiser may define or pay a certain amount of money into an account from which click-fees are deducted as the click-events come in. When the account is depleted, the advertisements are pulled unless the advertiser agrees to make up any negative balance. Alternatively, the advertiser may agree that they will pay for all click fees accrued over a defined time period. In this case, as click events come in, the click-fees are accrued in the account. When the time period expires, the advertisements are pulled and the account balance is billed to the advertiser. On top of all this, the advertiser may specify parameters of availability of the advertisement to control, mitigate, or regulate the potential for click events, such as by specifying where (logically or geographically) their ads are placed, specifying defined windows of time when the advertisements are to be made available and when they are not to be made available, etc. While such campaign parameters may affect the rate at which click events are accrued, the budget remains something that needs to be updated and tracked so long as an account has limited funds and/or an advertiser does not have an unlimited ability to pay for click charges that may be delayed. Most advertisers are sensitive to return on investment to some degree, and therefore, require some sort of budget to control the number of clicks and costs associated with the clicks that any given ad accrues during a time period.

When an advertisement (ad) is clicked by an Internet user, the web browser of that user is redirected to an ad serving system of an advertising (ad) broker (e.g., Yahoo!® or Google® or another search marketing division), which acts as an intermediary to the advertiser. When the browser is redirected, the serving system emits a click event. A system that may be used by the ad broker to emit such clicks includes a light-weight event system (LWES) that can transport clicks through varying channels (or routes) of a network as will be further discussed later. The LWES system may employ user datagram packets (UDP) to carry the click events, and an interface to the system may be supplied by related application programming interfaces (APIs). The term “light-weight” simply refers to the fact that the LWES system may transport a greater amount of click event data with fewer numbers of packets (e.g., UDPs). This usually means that the same information may be transferred with significantly fewer data packets, thus allowing such information (such as click event data) to be transmitted and processed quicker.

After the click is emitted, the user's browser is then re-directed again to the advertiser's web page corresponding to the clicked ad. The subscribing advertisers are those that have signed up under the ad broker and will thus have a user account with the ad broker against which the service fees may be charged. For the purpose of this application, any grouping of clicks by individual advertisers will be construed to relate to accounts of such advertisers, and vice versa. Accounts may be identified by an account identification (Id) to uniquely identify advertisers' accounts. For proper tracking, the emitted clicks include various click attributes that allow proper tracking of the same, which include at least the account Ids. Other click attributes include, but are not limited to: a click cost associated with each emitted click as negotiated with the ad broker (as discussed); a click identification (Id), which uniquely identifies a click; a search term searched for by the user, which results in the web page that is served the ad related to the emitted click; or combinations thereof.

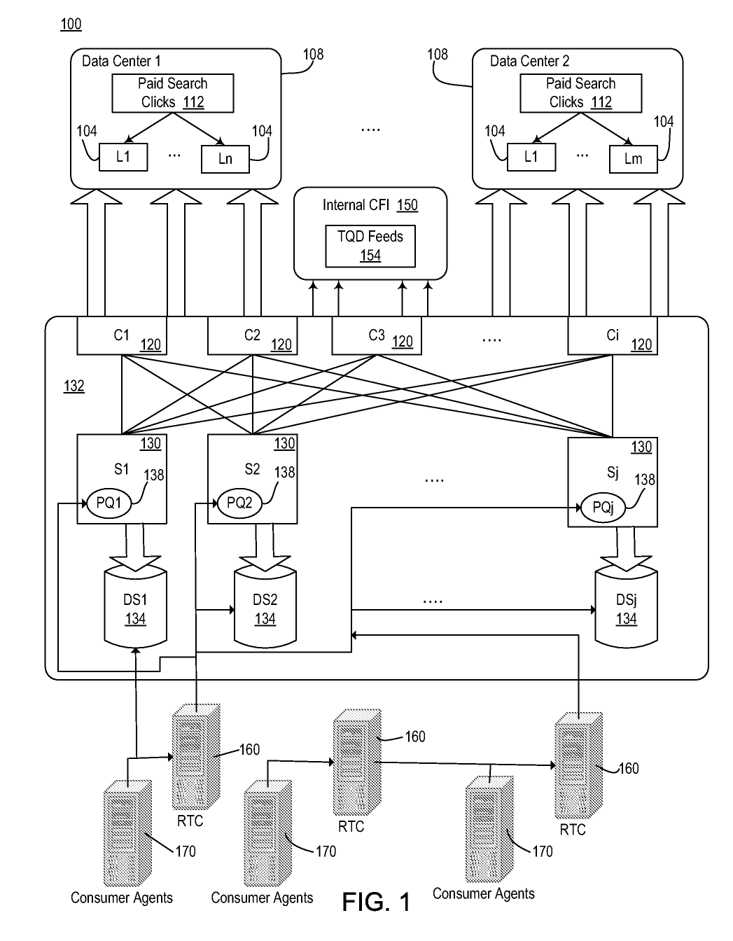

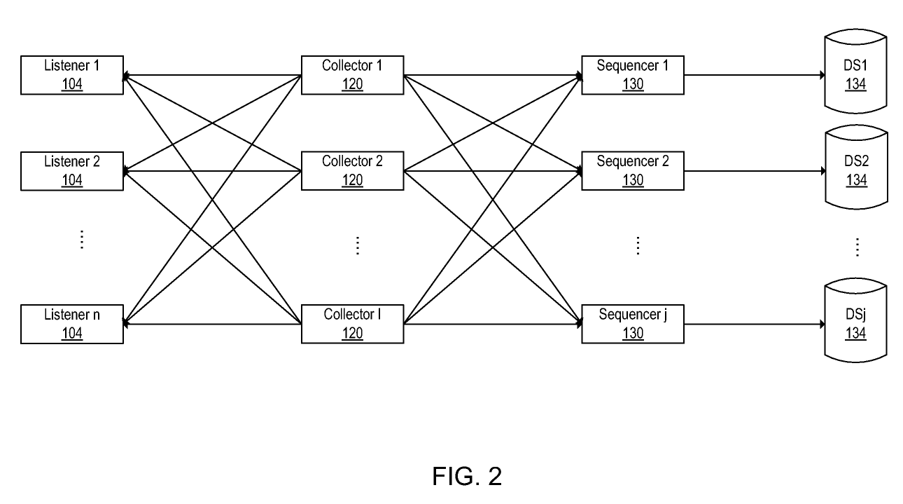

FIG. 1 depicts a system diagram of a distributed real-time click (RTC) system 100, showing the various stages through which click data is passed and persisted. FIG. 2 depicts an expanded portion of the system of FIG. 1, including a plurality of data pipelines. The RTC system 100 includes a plurality of listeners 104 located within data centers 108 that listen for real-time click events in the form of data packets, e.g., UDPs as discussed earlier. (The real-time click events are variably referred to herein as click event packets, click data, click event data, and click feeds.) The data centers 108 include facilities used to house computer systems and associated components, such as telecommunications, web and ad servers, and related storage systems (not shown). The listeners 104 are coupled with ad broker servers (not shown) of the ad serving system and listen for paid search clicks 112 generated therefrom. Ads may be served in many circumstances, including to web pages listed in a results list from a search query and to web pages browsed to by Internet users, among others. Each click coming from feeds of paid search clicks 112 encapsulates a variety of information elements, including the click attributes discussed previously.

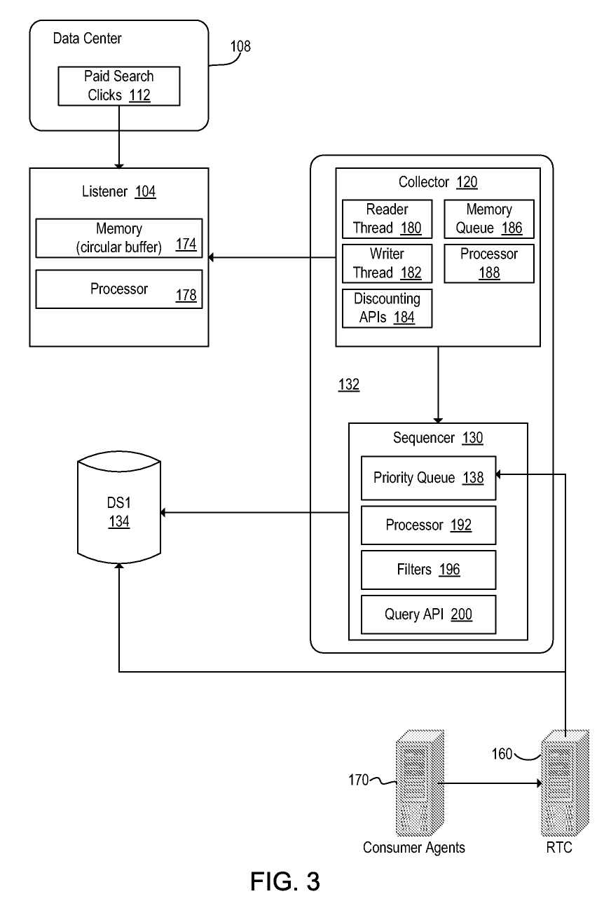

The RTC system 100 additionally includes a plurality of collectors 120 that act as intermediaries, pulling (or retrieving) data from the listeners 104 and pushing the data to a plurality of sequencers 130. The sequencers 130 are responsible for processing the click data, including performing click defrauding, and then persisting (or storing) the click data to real-time click databases 134, or distributed storage, for querying. Note that, in one embodiment, the databases 134 are persistent storage, or non-volatile memory. The sequencers 130 likewise each include a priority queue 138, which performs in-memory storage of click data for advertiser accounts and allows updating priority of each account as will be explained later. Accounts are tracked as groupings of clicks through the RTC system 100. Note that the collectors 120 and sequencers 130 may be combined within the RTC system 100 and collectively referred to as a RTC backend component 132, but separation of the two may provide for greater efficiency, and therefore, faster throughput of click event data, which will be explained further with reference to FIG. 3.

An internal common feed interface (CFI) 150 of the RTC system 100 includes a plurality of traffic quality discount (TQD) feeds 154. The click events data is also passed from the collectors 120 to these TQD feeds 154 to allow discounting click amounts based on partner traffic quality in the specific market identified by received hierarchical data. This process is also referred to as quality based discounting (QBD), which will be discussed in more detail below. In sum, the CFI 150 provides an interface to integrate with other systems (not shown) which process the TQD feeds 154 to apply discounts, among other functions.

A plurality of RTC servers 160 are coupled with the RTC system 100 to access the real-time click data persisted in the databases 134, or as updated in the priority queues 138 of the sequencers 130. Herein, the phrase “coupled with” is defined to mean directly connected to or indirectly connected through one or more intermediate components. Such intermediate components may include both hardware and software based components. (The RTC servers 160, for example by using Java, discussed in more detail below, may also obtain information about the collectors 120 and the listeners 104.) Allowing access to the databases 134 enables the RTC servers 160 to pull the most recent click event data in addition to the priority information, of the various user accounts. Furthermore, the RTC servers 160 provide the ability to remotely monitor the click event data stored in the memories of the various collectors 120 and sequencers 130, and/or facilitate a plurality of consumer agents 170 to do the same. An example of a consumer agent 170 includes budgeting agents 170 that query the click event data in order to timely and accurately keep user account budgets updated. Monitoring of the collectors 120 and sequencers 130 is also provided for purposes of engineering and technical troubleshooting. To the extent hardware or software issues can be detected and fixed ahead of time, the possibility of downed systems will be decreased, along with concomitant lost click event data.

The real-time click (RTC) system 100 guards against delays and diminishes the affects of pipeline failure by operating a plurality of pipelines, each carrying a portion of the real-time click data. The click event packets are also processed through volatile memory, and thus the amount of data that would be trapped in any given pipeline if it were to fail is greatly diminished. This implementation makes extensive use of in-memory processing and provides a solution that is tolerant of database crashes. The use of in-memory processing significantly decreases average click processing time from the range of 30-plus minutes in regular (or traditional) data pipelines to 3 seconds in the RTC system 100. In-memory processing through a plurality of pipelines also virtually guarantees that the accounts of advertisers will not have budget blow outs due to the unavailability of a budget storage or any other Oracle® database. Accordingly, any time the term “memory” or “in-memory” processing or storage is referred to herein, reference is being made to volatile memory, or processing and/or storing real-time click data in volatile memory.

FIG. 3 depicts a system diagram showing one pipeline extracted from the system of FIGS. 1 and 2, including further details of the listener 104, the collector 120 and the sequencer 130, the latter of the two which may be combined as a backend component 132 or implemented separately, as was described above. Note that the real-time listener 104 includes at least a volatile, in-memory circular buffer 174 and a processor 178 with which to listen for and store the click events in the circular buffer 174. Each listener 104 is configured to listen to a different channel for different click event feeds, such as from different data centers 108 for example, and hence provide horizontal scalability.

A channel is a route from a web or ad server (not shown) from which click events are expected. The LWES system is configurable to transport on different channels, wherein the serving side of a broker's ad server (not shown) from where the click is emitted is the “source” and the listener 104 is the “destination” where the click is received. The source can emit clicks on multiple channels and the destination can opt to receive on just certain channels. This allows fluid configuration of the RTC system 100 so that listeners 104 preferably fill their respective memory buffers 174 in as uniform a manner as possible.

As clicks are received by the listeners 104, they are stored in the circular buffer 174, such as a first-in-first-out (FIFO) memory. The listeners 104 also include two child processes referred to as a LWES listener and a command (CMD) listener (not shown). The LWES listener process consumes detected click event data from serving systems of the data centers 108, as discussed above. The LWES listener process, therefore, provides write functionality within the circular buffer 174. The CMD listener process sends the same click event data to the collector 120, thus allowing read functionality out of the circular buffer 174 in chunks of memory. Only one collector 120 may collect clicks from a listener 104 at any time so that the RTC system 100 does not collect and pass redundant/duplicative click events.

The listeners 104 are exposed to transmission control protocol (TCP)-based common interface, which is used by the collectors 120 to collect click data. Of course, any control protocol would work, and thus the implementation is not constrained to TCP-based technology. The same interface is also used by monitoring watch dog processes (or agents) (not shown) which periodically check the health status of individual listener 104 processes. This is done in the listener 104 by exposing the status (or STAT) command through the TCP interface. The STAT command returns an internal status for a running listener process. This interface may also be invoked via telnet in case RTC engineering needs to troubleshoot a running listener 104. The STAT command is preferably invoked only through privileged Internet protocol (IP) addresses. Monitoring agents can talk to listeners 104 every so often, such as every five minutes to stay updated. If this connection is not possible, then a listener 104 is “down” and an alert should be generated as to such.

The backend component 132 may include the collector 120 and the sequencer 130. The collectors 120, as discussed, are intermediaries of the RTC system 100 whose primary purpose is to pull the click data from the listeners 104 and then push the click data to the correct sequencers 130. Internally, the collector 120 may include a reader thread 180 and a writer thread 182. Inclusion of both threads 180, 182 provides greater efficiency as each is dedicated to respectively read and write operations, but both are not required for operation. The reader thread 180 continuously connects in round robin fashion to each listener 104 and collects the click data, e.g., every 100 milliseconds. What is collected is everything stored in the circular buffer 174 of the listener 104 since the last connection.

The collector 120 then invokes discounting application programming interfaces (APIs) 184 to apply discounts on individual click costs depending on the quality of each click. Note that whenever APIs are referred to herein, the term includes any type of remote call executed remotely over a network. The click data is then stored in a memory queue 186. The writer thread 182 then comes in and picks up all the data items available in the queue 186 and sends them one-by-one to the correct sequencer 130. The collectors 120 may be implemented in Java® language, and include a central processor 188 for implementation of the code that directs the collector 120. For instance, the processor 188 transforms click event data into Java® objects using TCP sockets. This disclosure, of course, should not be constrained to a specific software implementation such as Java®, which is recited here as exemplary and as perhaps the most common implementation known in the art.

Accounts (or groupings of clicks as discussed earlier) are labeled with identification (Id) and are partitioned based on a pre-assigned partitioned number. Each account Id belongs to only one partition, designated with a given partition number. Account partitioning is implemented to scale the RTC system 100 for future growth needs. If the click traffic grows significantly in the future, additional partitions may be added to the RTC system 100. Click event packets are mapped into N-minute time intervals (e.g. of 15 minutes each) of data packets. A hash code is taken of the account Id (or click grouping) number to which the data packets belong. A modulator operator is then applied on the result of the hash code of the account Id, which results in the partition number. The partition number indicates the specific pipeline (or partition) through which the click event data packets are traveling, specifically, to which sequencer 130 the collector 130 should send the data packets.

Quality-based discounting (QBDs) or traffic quality discounting (TQD) is implemented by the discounting APIs 184 in concert with the internal CFI 150 to give a certain score to various partners based on partner traffic quality in a specific market identified by hierarchical data as an input. This process may be an additional feature of the RTC system 100 that tries to estimate the quality of traffic from various partners. These partners are charged a different percentage of actual click costs depending on the score given. The higher quality web sites receive higher scores and are, therefore, charged more so that the partners and advertisers are paid more for higher levels of advertising traffic. The QBD or TQD may be implemented to traffic quality in general, and need not apply explicitly to partners.

The sequencers 130 are responsible for processing the click data packets and include a processor 192. Click data packets are partitioned equally and each sequencer 130 is responsible for processing data for a given partition, as discussed above. Each sequencer 130 then processes the data packets. Processing includes performing click defrauding as defined by a series of pluggable defrauding filters, and performing additional filtering, together implemented by filters 196 displayed in FIG. 3 (discussed below). Processing also may include aggregating click data packets for a given time window N′, such as 15 minutes, for a given account. The sequencers 130 then persist the defrauded, filtered, and aggregated click charges to distributed storage, e.g., they are stored in the databases 134, for querying. Distributed storage simply indicates that the click event data may be saved to a related database 134 where that database 134 may be shared amongst more than one sequencer 130.

The databases 134 may be MySQL databases using implementations of a real time click data access object (RTC_DAO) interface. There may be a certain number of instances of MySQL, e.g., one instance per sequencer 130. Each instance of MySQL handles a distinct set of accounts. The hashing mechanism discussed above is used to identify and lookup the appropriate MySQL instance. A common filer (not shown) may exist across all the databases 134 for storage. Likewise, a Spring Framework may be used to configure and lookup data sources for DAO implementations.

The Spring Framework is based on an inversion of control design pattern (IoC) and dependency injection. The fundamental principle of dependency injection for configuration is that application objects should not be responsible for looking up external dependencies. Instead, an IoC container should configure objects externalizing resource lookup from application code. This allows the IoC container to be more configurable and maintainable. The code is more focused on business logic rather than being cluttered with lookup of external resources, and it is easier to test.

Each sequencer 130 includes a priority queue 138 that is exposed which performs in-memory storage of click data packets based on account Ids and priority. Priority is based on a pluggable implementation of business rules, such as a number of clicks received or a cost associated therewith, for example, and is thus configurable to changing needs. As a result of this implementation, quick writes and lookups of accounts with highest priority can be queried for, and it allows budgeting-type systems to target accounts which are more sensitive to budgeting restrictions. Maintenance and retrieval of each next batch of accounts to be processed is controlled by the priority. In general, accounts with higher priority are processed in front of, or sooner than, accounts with lower priorities. The accounts, therefore, are generally processed in descending order of priority. Also, accounts that have received more clicks and/or are closer to running out of budget generally carry higher priorities to avoid budget blow outs.

Priority data may also be used to facilitate budgeting in real-time, e.g., data stored in the priority queue 138 is used by real-time consumer agents 170 to turn off accounts when they exceed their budgets. Priority data is also used to predict the next interval spent based on the last N intervals. This prediction may be used as a throttle rate calculation for the next interval. The priority data may also augment click through protection (CTP) clicks to calculate the budget remaining for the rest of the day. A fallback mechanism may be employed to turn off accounts in time, even if a CTP feed is delayed. Supplemental CTP feed data may be generated to get the latest spend information used for budgeting calculations.

The priority queue 138 maintains a list of accounts prioritized by number of clicks received between the last run of the consumer agent 170 and the present time. Priority is typically reset at the beginning of each day when a first click is received for an account. The priority queue 138 maintains the last click timestamp for each account for increased optimized searches.

The processing of click data packets by the sequencers 130 may include some of the following general implementation, provided as exemplary only. Periods of time are discarded that are beyond some M intervals of time in the past from the current time period. Account data packets are discarded that are not applicable for the partition to which the sequencer 130 is assigned. This is just a double check measure for each sequencer 130 so that each processes just those account Ids to which each is assigned. The click event data may be aggregated at the campaign level. This may include summing raw click charge amounts for a time period, an account Id, and a campaign Id. The aggregating may also include summing definitive click charge amounts that define the raw click charges while discarding some click charges by the click filters 196.

The defrauding filters 196 protect against end users searching for a particular keyword on a search engine and that repeatedly click on the same ad. Just the first click would be charged for. Click through protection (CTP) is also provided by using filters 196 that include I.P. address tracking. Filtering of click data with the filters 196 may include a number of different implementations, and the following are only exemplary. One may include a filter 196 to remove duplicates of session resource key and search resource key click events from the circular buffer 174. Another may include a filter 196 to remove duplicates of click Id results from the click events, also coming from the circular buffer 174. Yet another filter 196 may be based on a blacklist of client IPs from the click events, which are removed when detected because the IP address from which the click events came is blacklisted.

Each sequencer 130 (or alternatively each RTC server 160) also includes a query application programming interface (API) 200, which allows remote clients, such as consumer agents 170, to query the RTC data packets based on certain criteria such as time intervals, account Id, campaign Id, and priority in high traffic accounts. The implementation of the query API 200 quickly retrieves aggregates and returns click data for the given inputs. Fault tolerance is built into the system and can retrieve data even if subsets of partitions are unavailable.

The query API 200 may be implemented with Enterprise JavaBean (EJB) by Sun Microsystems®, part of their Java® management extensions (JMX) technology, for the business logic required. The management of the query API 200 application that is defined by the EJB may further be implemented by management beans (MBeans). MBeans can provide a client interface within the remote client machine and can be exposed to as many clients as desired. MBeans are Java objects that represent resources to be managed.

An MBean has a management interface including: named and typed attributes that can be read and written; named and typed operations that can be invoked; and typed notifications that can be emitted by the Mbean. For example, an MBean representing an application's configuration could have attributes representing the different configuration parameters, such as a cache size. Reading the CacheSize attribute would return the current size of the cache. Writing CacheSize would update the size of the cache, potentially changing the behavior of the running application. An operation such as save could store the current configuration persistently. The MBean could send a notification such as ConfigurationChangedNotification when the configuration changes.

Budgeting agents (such as 170) get access to the sequencer 130 databases 134 through the MBeans of the EJB with standard interfaces within the RTC system 100. The EJB will connect to the priority queue 138 to get account Ids listed in accordance with priorities stored therein. Once the EJB has the account Ids, it connects to the database 134 to get the amount of money the number of clicks therein is worth. Query APIs 200 also use JMX technology to expose MBeans in order to expose API 200 internal health and status. The MBeans expose interesting statistics about the query APIs 200 that RTC monitoring use to plot graphs and report incidences.

Finally, the RTC system 100 exposes a set of APIs for remote method invocation (RMI), or invocation by any remote call system, for monitoring the memories 186, 138 of each collector 120 and sequencer 130, respectively. The RMI (or remote call) monitoring may also be implemented in Java®. Java RMI enables a programmer to create distributed Java® technology-based to Java® technology-based applications, in which the methods of remote Java objects can be invoked from other Java® virtual machines (VM), possibly on different hosts. RMI uses object serialization to marshal and unmarshal parameters and does not truncate types, supporting true object-oriented polymorphism.

Each collector 120 and sequencer 130, through RMI APIs, exposes a set of attributes and data points that application support and operations engineering can process to do a periodic query for process health and also do a status check. Sets of tools may be written on top of the APIs to query process health in case RTC engineering needs to do trouble shooting. RMI-based monitoring also exposes interesting statistics about the RTC system 100 pipelines such as, for instance, memory usages, free memory available, total memory available, average click processing time for a day, aggregated click count for a day, how many accounts have in the priority queue 138, how much time it takes to store data in the database 134, etc. RMI-based monitoring typically includes updates every so often, e.g., every five minutes.

RMI-based monitoring may be implemented through simple JMX MBeans exposing statistics (STATS) about each method for the EJB, including: total method call count; last time a method was called; and total number of objects returned. Each sequencer 130 may expose the STATS command via an RMI object, including: average for SQL inserts and updates; total processing average; last execute time; and a number of clicks filtered for each click filter 196.

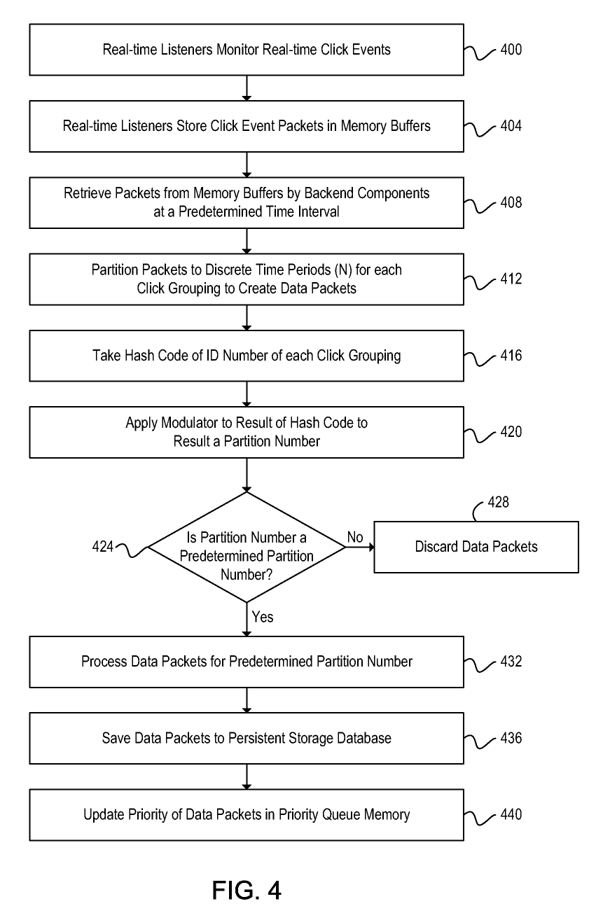

FIG. 4 is a flow chart depicting exemplary operation of the system disclosed in FIGS. 1-3 and demonstrating the flow of click event data through the RTC system 100 and how the RTC system 100 listens for, collects, and processes the same. Additional and/or different operations are contemplated, and therefore, the operations depicted in FIG. 4 should not be taken as limiting, but as exemplary.

At block 400, real-time listeners 104 monitor (or listen for) real-time click events in the form of click event packets containing attributes as listed above. The listeners 104 store click event packets in circular memory buffers 174, at block 404. Click event packets are retrieved by backend components 132 at a predetermined time interval, at block 408. Click event packets are partitioned to discrete time periods (N) for each click grouping of a plurality of click groupings (or an account) to create data packets of N-minute time periods, at block 412. A hash code is executed on an identification (Id) number of each click grouping (or account), at block 416. A modulator is applied to the result of the hashed Id number to produce a partition number, at block 420.

At block 424, the method determines whether or not the partition number matches a predetermined partition number for which the backend component 132 will process the corresponding data packets, at block 432. If the answer is no, the data packets are discarded at block 428. Discarding packets by the backend component 132 is one reason that it is more efficient for the backend component 132 to include both collectors 120 and sequencers 130 so that the collectors 120 determine the partition of each data packet and sends them on to the correct sequencer 130 to begin with (avoiding discarding inappropriate data packets). The processing work by the collectors 120 to direct data packets to the correct sequencers 130 may also be shared across all (or at least some) of the collectors 120 of the RTC system 100, thus also improving the efficiency of data packet flow therethrough. If the answer is yes at block 424, the data packets for the predetermined partition number are processed, at block 436. The data packets are also saved to persistent storage, a database 134 for instance, at block 436.

Finally, a priority related to the data packets is stored in a priority queue memory 138, at block 440, wherein a priority of each advertiser account is updated. For instance, accounts generating a higher volume of click events and/or a higher total cost of the click events may be accorded a higher priority. To the extent that priority data is also updated with budget balance, accounts closer to exceeding the budget balance for a predetermined time period may also receive a higher priority. If such accounts do exceed their budget amounts, they can be turned off by real-time budgeting agents 170 or as discussed above. Click event data packets with higher priority will generally be processed and saved to the database 134 before those will a lower priority.

In the foregoing description, numerous specific details of programming, software modules, user selections, network transactions, database queries, database structures, etc., are provided for a thorough understanding of various embodiments of the systems and methods disclosed herein. However, the disclosed system and methods can be practiced with other methods, components, materials, etc., or can be practiced without one or more of the specific details. In some cases, well-known structures, materials, or operations are not shown or described in detail. Furthermore, the described features, structures, or characteristics may be combined in any suitable manner in one or more embodiments. The components of the embodiments as generally described and illustrated in the Figures herein could be arranged and designed in a wide variety of different configurations.

The order of the steps or actions of the methods described in connection with the disclosed embodiments may be changed as would be apparent to those skilled in the art. Thus, any order appearing in the Figures, such as in flow charts, or in the Detailed Description is for illustrative purposes only and is not meant to imply a required order.

Several aspects of the embodiments described are illustrated as software modules or components. As used herein, a software module or component may include any type of computer instruction or computer executable code located within a memory device and/or transmitted as electronic signals over a system bus or wired or wireless network. A software module may, for instance, include one or more physical or logical blocks of computer instructions, which may be organized as a routine, program, object, component, data structure, etc. that performs one or more tasks or implements particular abstract data types.

In certain embodiments, a particular software module may include disparate instructions stored in different locations of a memory device, which together implement the described functionality of the module. Indeed, a module may include a single instruction or many instructions, and it may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices.

Various modifications, changes, and variations apparent to those of skill in the art may be made in the arrangement, operation, and details of the methods and systems disclosed. The embodiments may include various steps, which may be embodied in machine-executable instructions to be executed by a general-purpose or special-purpose computer (or other electronic device). Alternatively, the steps may be performed by hardware components that contain specific logic for performing the steps, or by any combination of hardware, software, and/or firmware. Embodiments may also be provided as a computer program product including a machine-readable medium having stored thereon instructions that may be used to program a computer (or other electronic device) to perform processes described herein. The machine-readable medium may include, but is not limited to, floppy diskettes, optical disks, CD-ROMs, DVD-ROMs, ROMs, RAMs, EPROMs, EEPROMs, magnetic or optical cards, propagation media or other type of media/machine-readable medium suitable for storing electronic instructions. For example, instructions for performing described processes may be transferred from a remote computer (e.g., a server) to a requesting computer (e.g., a client) by way of data signals embodied in a carrier wave or other propagation medium via a communication link (e.g., network connection).

1. A real-time click system to process advertisement (ad) clicks, comprising:
a real-time listener operative to listen for, and store in a memory, a plurality of click event packets emitted by an ad server when corresponding ads are clicked by web users;
a sequencer to store the click event packets in a database; and
a collector coupled with the real-time listener and the sequencer and operative to retrieve the plurality of click event packets, upon request, from the memory at a predetermined time interval, wherein the collector determines a partition number associated with each of the plurality of click event packets and sends to the sequencer the click event packets having a partition number corresponding thereto.

2. The system of claim 1, wherein the listener collects the plurality of click event packets by listening for light-weight event system (LWES) events emitted by the ad server, and wherein the memory comprises a circular buffer memory.

3. The system of claim 1, further comprising a plurality of the listeners, a plurality of the collectors, and a plurality of the sequencers to form a plurality of data pipelines in which the plurality of collectors can retrieve click event packets from any of the plurality of listeners, and only click event packets of a pre-determined partition number are sent to corresponding sequencers.

4. The system of claim 3, wherein only one collector retrieves packets from any given listener at a time and wherein each collector maps the pulled click event packets into a plurality of data packets of discrete time periods (N) for each advertiser.

5. The system of claim 1, further comprising:
a priority queue memory of the sequencer operative to enable updating priority of the click event packets corresponding to each of a plurality of advertiser accounts based on a pluggable implementation of at least one business rule.

6. The system of claim 5, wherein the at least one business rule comprises a rule that tracks at least one of a number of clicks and a cost for the number of clicks.

7. The system of claim 5, wherein the click event packets are processed within the priority queue memory and then stored in the database of each sequencer in descending order of priority.

8. The system of claim 7, wherein to process the click event packets the sequencer applies filters thereto, including at least a defrauding filter, and aggregates the data packets into a time window (N′).

9. The system of claim 1, wherein each of the collector and sequencer comprise a memory, wherein at least one of the collector and the sequencer expose the data packets in their respective memories using a remote call that enables application programming interfaces (APIs) of remote processes to monitor the click event packets and memory usage for statistical purposes.

10. The system of claim 1, further comprising:
a query application programming interface (API) to query the database on certain criteria to provide access to the system by remote clients, wherein the query API includes a fault tolerance that can retrieve click event packets even if subsets of partitions are unavailable.

11. The system of claim 1, wherein the real-time listener exposes a STAT command through a control protocol interface, and in response to the STAT command, the real-time listener returns an internal status for a running listener process.

12. A method of processing real-time advertisement (ad) clicks in a real-time click system, comprising:
listening by a plurality of real-time listeners for click event packets emitted by an ad server when an ad is clicked by web users;
storing the click event packets in a memory buffer of each listener in real-time;
pulling the click event packets from the memory buffers by a plurality of backend components at a predetermined time interval;
determining a partition number associated with each of the click event packets;
processing the data packets for a predetermined partition number; and
storing the data packets in a database corresponding to the predetermined partitioned number, wherein the data packets become accessible by remote agents for querying.

13. The method of claim 12, wherein the backend component comprises a collector to pull the click event packets from the plurality of memory buffers, and a sequencer to receive the click event packets from the collector having a partition number corresponding thereto, wherein the sequencer processes the data packets and stores the data packets in the database.

14. The method of claim 13, further comprising:
partitioning the click event packets into data packets of discrete time periods (N) for each of a plurality of advertisers and based on the predetermined partition number.

15. The method of claim 14, further comprising:
updating a priority of the data packets in a priority queue memory of the respective sequencers, wherein the data packets of each advertiser receives a priority based on a pluggable implementation of at least one business rule, and wherein the data packets are processed and stored in the database in descending order of priority.

16. The method of claim 15, wherein the at least one business rule comprises a rule that tracks at least one of a number of clicks and a cost of the number of clicks, the method further comprising:
giving a higher priority to the data packets of advertisers that at least one of receive more click events and incur higher costs for the user clicks.

17. The method of claim 16, further comprising:
updating a budget balance of an advertiser based on the cost of the number of clicks; and
turning off the advertiser account if the cost of the number of clicks exceeds the budget balance during a pre-determined time period.

18. The method of claim 14, wherein processing the data packets comprises:
executing click defrauding by the sequencer as defined by a series of pluggable defrauding filters; and
aggregating the data packets into a time window (N′) for each advertiser account.

19. The method of claim 14, further comprising:
enabling remote clients to query the data packets in the database on certain criteria through a query application programming interface (API).

20. The method of claim 14, wherein the collector includes a memory, the method further comprising:
exposing the data packets in the memories of at least one of the collectors and the sequencers using a remote call that enables application programming interfaces (APIs) of remote processes to monitor the data packets and memory usage for statistical purposes.

21. The method of claim 14, wherein the predetermined partition number is determined through:
taking a hash code of each of a plurality of account identifications associated with the data packets; and
applying a modulator operator on the result of each hash code to result the partition number for each data packet.

22. A method of processing real-time advertisement (ad) clicks in a real-time click system, comprising:
receiving into memory a plurality of data packets including attributes of captured click events, wherein the data packets are pre-partitioned into discrete time periods (N) for each of a plurality of advertiser click groupings, and wherein the data packets belong to at least one of a plurality of predetermined partition numbers;
updating a priority of the data packets in a priority queue memory, wherein each click grouping receives a priority based on a pluggable implementation of at least one business rule;
processing the data packets for a predetermined partition number in descending order of the priority; and
saving the processed data packets to a database.

23. The method of claim 22, wherein processing the data packets comprises at least one of:
discarding a certain number (M) of time intervals in the past from a current time period; and
aggregating clicks at a campaign level by summing raw click charge amounts for each time period N for each click grouping.

24. The method of claim 22, further comprising:
executing click-through protection that includes removal of clicks from the data packets through at least one of:
filtering the click events to remove duplicate click events;
tracking internet protocol (IP) addresses of searchers by using a series of pluggable defrauding filters; and
blacklisting IP addresses that meet criteria of the series of pluggable defrauding filters.

25. The method of claim 24, further comprising:
enabling remote clients to query the click events data packets in the database on certain criteria through a remote application interface.
